(19) United States
(12) Patent Application Publication
(10) Pub. No.: US 2026/0211153 A1
(43) Pub. Date: Jul. 23, 2026

(54) SYSTEM AND METHOD FOR PREDICTING FRACTURE DEVELOPMENT IN TIGHT SANDSTONE BASED ON COUPLING CONSTRAINT OF MULTIPLE GEOLOGICAL PARAMETERS

(71) Applicant: Chengdu University of Technology, Chengdu (CN)

(72) Inventors: Lei LIU, Chengdu (CN); Nachuan SONG, Chengdu (CN); Xin LUO, Chengdu (CN); Zexin DU, Chengdu (CN)

(21) Appl. No.: 19/570,283

(22) Filed: Mar. 18, 2026

(30) Foreign Application Priority Data
Feb. 4, 2026 (CN) 202610161538.3
Mar. 11, 2026 (CN) 202610295207.9

(51) Int. Cl. G01V 20/00; E21B 43/26; E21B 49/00

(52) U.S. Cl. CPC G01V 20/00; E21B 43/26; E21B 49/005; E21B 2200/20

(57) ABSTRACT

A system for predicting fracture development in tight sandstone under a coupling constraint of multiple geological parameters, including a first processor, a second processor, a third processor, a fourth processor, a fifth processor and a sixth processor. The first processor establishes a standardized geological database. The fifth processor establishes a quantitative coupling control model of “geological structure-sedimentary microfacies-high-frequency sequences” based on a tectonic characteristic identified by the fourth processor, a lithologic characteristic identified by the third processor and a sequence characteristic identified by the second processor. The sixth processor realizes hierarchical classification of favorable zones for fracture development based on comprehensive quantitative values of the lithologic characteristic, the lithologic characteristic and the sequence characteristic. A method for predicting fracture development in tight sandstone is also provided.

### CROSS-REFERENCE TO RELATED APPLICATIONS

This application claims the benefit of priority from Chinese Patent Application Nos. 202610161538.3 and 202610295207.9, respectively filed on Feb. 4, 2026 and Mar. 11, 2026. The content of the aforementioned application, including any intervening amendments made thereto, is incorporated herein by reference in its entirety.

### TECHNICAL FIELD

This application relates to oil and gas exploration and development, and more particularly to a system and method for predicting fracture development in tight sandstone under a coupling constraint of multiple geological parameters.

### BACKGROUND

Accurately predicting fracture development patterns constitutes one of the core factors for promoting the efficient development of tight sandstone gas reservoirs. Traditional prediction methods for fracture development in tight sandstone mostly rely on single geological parameters or single geophysical attributes for analysis. These methods are difficult to adapt to the geological setting characterized by the superposition of multi-stage tectonic movements and complex lithologic associations, resulting in insufficient accuracy and reliability of prediction results. Although some comprehensive fracture development prediction methods have attempted to introduce multi-factor analysis, such methods still fail to establish a clear quantitative coupling model and fail to focus on the core control logic of fracture development, i.e., geological structure-sedimentary microfacies-high-frequency sequences, so the prediction accuracy and reliability remain to be improved.

It can be seen that traditional prediction methods for fracture development in tight sandstone are inadequate in providing precise geological foundations for exploration planning, horizontal well trajectory optimization, and fracturing design. This leads to excessively high exploration costs and a high proportion of low-efficiency wells and dry wells, and severely compromises the economic benefits and development efficiency of tight sandstone oil and gas reservoirs.

### SUMMARY

An object of the disclosure is to provide a system and method for predicting fracture development in tight sandstone under a coupling constraint of multiple geological parameters, so as to address the problem that the prediction accuracy and reliability of traditional prediction methods for fracture development in tight sandstone remain to be improved.

In order to achieve the above object, the following technical solutions are adopted.

In a first aspect, this application provides a system for predicting fracture development in tight sandstone under a coupling constraint of multiple geological parameters, comprising:
a first processor;
a second processor;
a third processor;
a fourth processor;
a fifth processor; and
a sixth processor;
wherein the first processor is configured to acquire basic geological data of a target tight sandstone gas reservoir area, and perform standardization on the basic geological data to form a standardized geological database;
the second processor is configured to perform multi-order sequence boundary identification by means of high-resolution sequence stratigraphy to delineate a plurality of sequence boundaries based on the standardized geological database, identify dominant intervals for fracture development in combination with analysis of fracture development parameters and according to a range of each of the plurality of sequence boundaries, and determine a vertical distribution range and lateral distribution characteristics of the dominant intervals;
the third processor is configured to, based on the standardized geological database and in combination with core observation and logging curve response characteristics, plot a distribution map of sedimentary microfacies for the dominant intervals by using a spatial constraint of a seismic attribute fusion map, and determine a spatial distribution range and boundary characteristics of the sedimentary microfacies;
the fourth processor is configured to extract formation curvature parameters by means of a multi-scale volumetric curvature calculation method based on the standardized geological database, calculate a linear distance from each drilling location to a fault through fault interpretation and fine characterization, delineate predicted fracture development zones along the dominant intervals and generate a predicted fracture development zone map based on the formation curvature parameters and the linear distance and in combination with tectonic stress field analysis, and determine a boundary range, fracture development intensity grade and spatial distribution characteristics of each of the predicted fracture development zones;
the fifth processor is configured to perform statistics on a fracture development condition from imaging logging to obtain a statistical result, acquire a quantified value of a tectonic characteristic, a quantified value of a lithological characteristic and a quantified value of a sequence characteristic, perform normalization on the quantified value of the tectonic characteristic to obtain a first normalized value, perform normalization on the quantified value of the lithological characteristic to obtain a second normalized value, perform normalization on the quantified value of the sequence characteristic to obtain a third normalized value, compare the first normalized value, the second normalized value and the third normalized value with the statistical result, respectively, to determine an influence weight of each of the tectonic characteristic, the lithological characteristic and the sequence characteristic on fracture development, and calculate a comprehensive quantified value of each of the tectonic characteristic, the lithological characteristic and the sequence characteristic by using a weighted combination method based on the influence weight; and
the sixth processor is configured to perform spatial superimposition of the predicted fracture development zone map with a sedimentary microfacies distribution map, and perform hierarchical classification of favorable zones for fracture development in combination with the comprehensive quantified value.

In a second aspect, this application provides a method for predicting fracture development in tight sandstone under a coupling constraint of multiple geological parameters, comprising:
(1) acquiring basic geological data of a target tight sandstone gas reservoir area, and performing standardization on the basic geological data to form a standardized geological database;
(2) performing multi-order sequence boundary identification by means of high-resolution sequence stratigraphy to delineate a plurality of sequence boundaries based on the standardized geological database, identifying dominant intervals for fracture development in combination with analysis of fracture development parameters and according to a range of each of the plurality of sequence boundaries, and determining a vertical distribution range and lateral distribution characteristics of the dominant intervals;
(3) based on the standardized geological database and in combination with core observation and logging curve response characteristics, plotting a distribution map of sedimentary microfacies for the dominant intervals by using a spatial constraint of a seismic attribute fusion map, and determining a spatial distribution range and boundary characteristics of the sedimentary microfacies;
(4) extracting formation curvature parameters by means of a multi-scale volumetric curvature calculation method based on the standardized geological database, calculating a linear distance from each drilling location to a fault through fault interpretation and fine characterization, delineating predicted fracture development zones along the dominant intervals and generating a predicted fracture development zone map based on the formation curvature parameters and the linear distance and in combination with tectonic stress field analysis, and determining a boundary range, fracture development intensity grade and spatial distribution characteristics of each of the predicted fracture development zones;
(5) performing statistics on a fracture development condition from imaging logging to obtain a statistical result, acquiring a quantified value of a tectonic characteristic, a quantified value of a lithological characteristic and a quantified value of a sequence characteristic, performing normalization on the quantified value of the tectonic characteristic to obtain a first normalized value, performing normalization on the quantified value of the lithological characteristic to obtain a second normalized value, performing normalization on the quantified value of the sequence characteristic to obtain a third normalized value, comparing the first normalized value, the second normalized value and the third normalized value with the statistical result, respectively, to determine an influence weight of each of the tectonic characteristic, the lithological characteristic and the sequence characteristic on fracture development, and calculating a comprehensive quantified value of each of the tectonic characteristic, the lithological characteristic and the sequence characteristic by using a weighted combination method based on the influence weight; and
(6) performing spatial superimposition of the predicted fracture development zone map with a sedimentary microfacies distribution map, and performing hierarchical classification of favorable zones for fracture development in combination with the comprehensive quantified value.

Compared to the prior art, the present disclosure has the following beneficial effects.

The system provided by the present disclosure constructs a scientific fracture development prediction model under a coupling constraint of multiple geological parameters, which significantly enhances prediction accuracy and reliability and effectively overcomes the technical bottlenecks inherent in conventional prediction methods, that is, domination by a single factor, reliance on qualitative analysis and low prediction precision. Furthermore, the system furnishes scientific and robust technical support for exploration target optimization, drilling path planning and fracturing scheme improvement of tight sandstone gas reservoirs, thereby boosting exploration success rate, mitigating development risks and driving the efficient and profitable development of complex tight sandstone gas reservoirs.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a is a schematic diagram of a system for predicting fracture development in tight sandstone under a coupling constraint of multiple geological parameters in accordance with an embodiment of the present disclosure;

FIG. 2 is a flow chart of a method for predicting fracture development in tight sandstone under a coupling constraint of multiple geological parameters in accordance with an embodiment of the present disclosure;

FIG. 3a shows a seismic profile map of the Anyue area in accordance with an embodiment of the present disclosure;

FIG. 3b shows a sequence division map of the Anyue area in accordance with an embodiment of the present disclosure;

FIG. 4 shows a sedimentary microfacies distribution map of peripheral intervals of a maximum flooding surface the 2nd Submember of the 3^{rd} Member of the Xujiahe Formation (T₃x₃²) in the Anyue area in accordance with an embodiment of the present disclosure;

FIG. 5 shows tectonic characteristic-guided fracture likelihood results of the peripheral intervals in accordance with an embodiment of the present disclosure;

FIG. 6 shows a map of favorable zones for fracture development of the T₃x₃² in the Anyue area in accordance with an embodiment of the present disclosure; and

FIG. 7 shows relationship between the favorable zones for fracture development and oil-gas production in the T₃x₃² in the Anyue area in accordance with an embodiment of the present disclosure.

### DETAILED DESCRIPTION OF EMBODIMENTS

The technical solutions in the embodiments of the present disclosure will be described clearly and completely below with reference to the accompanying drawings in the embodiments of the present disclosure.

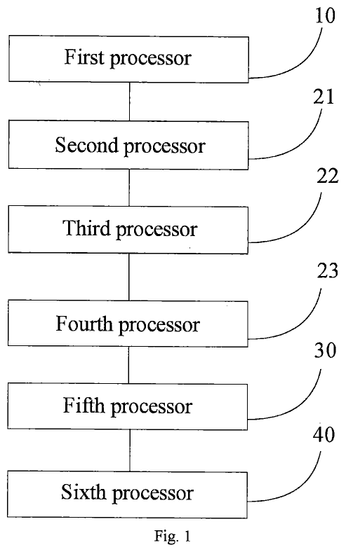

Referring to FIG. 1, a system for predicting fracture development in tight sandstone under a coupling constraint of multiple geological parameters is provided.

In this embodiment, the system includes a first processor 10, a second processor 21, a third processor 22, a fourth processor 23, a fifth processor 30 and a sixth processor 40.

The first processor 10 is configured to acquire basic geological data of a target tight sandstone gas reservoir area, and perform standardization on the basic geological data to form a standardized geological database.

The second processor 21 is configured to perform multi-order sequence boundary identification by means of high-resolution sequence stratigraphy to delineate a plurality of sequence boundaries based on the standardized geological database, identify dominant intervals for fracture development in combination with analysis of fracture development parameters and according to a range of each of the plurality of sequence boundaries, and determine a vertical distribution range and lateral distribution characteristics of the dominant intervals.

The third processor 22 is configured to, based on the standardized geological database and in combination with core observation and logging curve response characteristics, plot a distribution map of sedimentary microfacies for the dominant intervals by using a spatial constraint of a seismic attribute fusion map, and determine a spatial distribution range and boundary characteristics of the sedimentary microfacies.

The fourth processor 23 is configured to extract formation curvature parameters by means of a multi-scale volumetric curvature calculation method based on the standardized geological database, calculate a linear distance from each drilling location to a fault through fault interpretation and fine characterization, delineate predicted fracture development zones along the dominant intervals and generate a predicted fracture development zone map based on the formation curvature parameters and the linear distance and in combination with tectonic stress field analysis, and determine a boundary range, fracture development intensity grade and spatial distribution characteristics of each of the predicted fracture development zones.

The fifth processor 30 is configured to perform statistics on a fracture development condition from imaging logging to obtain a statistical result, acquire a quantified value of a tectonic characteristic, a quantified value of a lithological characteristic and a quantified value of a sequence characteristic, perform normalization on the quantified value of the tectonic characteristic to obtain a first normalized value, perform normalization on the quantified value of the lithological characteristic to obtain a second normalized value, perform normalization on the quantified value of the sequence characteristic to obtain a third normalized value, compare the first normalized value, the second normalized value and the third normalized value with the statistical result, respectively, to determine an influence weight of each of the tectonic characteristic, the lithological characteristic and the sequence characteristic on fracture development, and calculate a comprehensive quantified value of each of the tectonic characteristic, the lithological characteristic and the sequence characteristic by using a weighted combination method based on the influence weight.

The sixth processor 40 is configured to perform spatial superimposition of the predicted fracture development zone map with a sedimentary microfacies distribution map, and perform hierarchical classification of favorable zones for fracture development in combination with the comprehensive quantified value.

In some embodiments, the basic geological data include two-dimensional (2D) seismic data, three-dimensional (3D) seismic data, drilling core sample data, imaging logging data, conventional logging data and geological survey reports.

In some embodiments, the standardization is performed through the following steps.

The 2D seismic data and the 3D seismic data are respectively subjected to pretreatment, including denoising and amplitude correction.

Depth matching and outlier elimination are performed on a logging curve in the conventional logging data.

Lithologic identification and fracture parameter statistics are performed on the drilling core sample data, and a corresponding relationship between cores and logging responses is established. The fracture parameters include dip angle, strike, density and filling characteristics of fractures.

In some embodiments, the second processor 21 is specifically configured to:
based on the standardized geological database and in combination with logging curve cyclicity characteristics, a seismic reflection termination relationship and core sedimentary sequence analysis, perform multi-order sequence boundary identification by means of high-resolution sequence stratigraphy to delineate the plurality of sequence boundaries, and determine the range, genetic type and distribution pattern of each of the plurality of sequence boundaries, where the sequence boundaries include at least one of short-term cycle boundaries, medium-term cycle boundaries and flooding surfaces, the short-term cycle boundaries and the medium-term cycle boundaries are sedimentary cycle boundaries divided on the basis of different time scales, corresponding to sedimentary cycle periods of different durations respectively, and the flooding surface is a key boundary of continental lacustrine basins in sequence stratigraphy, referring to an isochronous surface corresponding to the time when the lake level reaches its maximum and the lake shoreline advances farthest landward within one cycle; and
analyze a constraining mechanism of a sequence structure on fracture development by performing statistics on the fracture development parameters of the plurality of sequence boundaries and cycle positions; and according to the range of each of the plurality of sequence boundaries, identify the dominant intervals for fracture development, and determine the vertical distribution range and the lateral distribution characteristics of the dominant intervals, where the fracture development parameters include density and effectiveness of fractures.

In some embodiments, the third processor 22 is specifically configured to:
acquire the drilling core sample data and the conventional logging data from the standardized geological database;
based on the drilling core sample data and the conventional logging data, identify a lithology type of each of the dominant intervals through core observation, analyze a rock structure, grain sorting and mineral composition of each of the dominant intervals, and establish a lithology identification model based on the logging curve response characteristics to classify types of lithological combinations of the dominant intervals, and classify the sedimentary microfacies according to the types of the lithological combinations;
perform spatial constraining by using the seismic attribute fusion map, and determine the spatial distribution range and the boundary characteristics of the sedimentary microfacies; and
plot the sedimentary microfacies distribution map for the dominant intervals to present a spatial distribution pattern of the lithological combinations and the sedimentary microfacies.

In some embodiments, the fourth processor 23 is specifically configured to:
acquire the 2D seismic data, the 3D seismic data, the imaging logging data and the conventional logging data from the standardized geological database;
based on the 2D seismic data, the 3D seismic data, the imaging logging data and the conventional logging data, extract the formation curvature parameters by means of the multi-scale volumetric curvature calculation method, and establish a positive quantitative correlation between the formation curvature parameters and the number of developed fractures through statistical analysis, where the formation curvature parameters include formation average curvature, maximum positive curvature and minimum negative curvature, the number of the developed fractures includes a total number of fractures and the number of various types of fractures, and the number of the various types of fractures includes the number of inclined fractures and the number of high-angle fractures, the inclined fracture refers to a fracture with a dip angle ranging from 15° to 45°, and the high-angle fracture refers to a fracture with a dip angle greater than 45° relative to a horizontal plane;
calculate the linear distance from each drilling location to a major fracture-controlling fault through fault interpretation and fine characterization, and analyze a distribution pattern of stress gradient around faults, so as to determine a negative correlation between each linear distance and fracture development density, where the major fracture-controlling fault is determined through the fault interpretation and statistical analysis of fracture development;
construct a quantitative response model of tectonics to fracture development according to tectonic stress field analysis and in combination with the formation curvature parameters and the linear distance;
based on the quantitative response model, combine tectonic-guided filtering with a C2 coherence algorithm by using a tectonic-guided fracture likelihood prediction algorithm, and calculate a similarity result of seismic data via weighted smoothing operation, so as to obtain a maximum likelihood attribute data volume;
calibrate target horizons, where the dominant intervals are configured as the target horizons for fracture likelihood prediction; and along the target horizons, intercept maximum likelihood attribute values of all seismic sample points at the depth of the target horizons by using a horizon-following attribute extraction function of a seismic data interpretation platform, so as to form planar stratal slices; and
construct a fracture likelihood result map based on the planar stratal slices, delineate the predicted fracture development zones along the dominant intervals on the fracture likelihood result map and generate the predicted fracture development zone map, and determine the boundary range, fracture development intensity grade and spatial distribution characteristics of the predicted fracture development zones.

In some embodiments, the tectonic-guided filtering is combined with the C2 coherence algorithm by using the tectonic-guided fracture likelihood prediction algorithm through the following equation:

$$s ( {i}_{1} , {i}_{2} , {i}_{3} ) = \frac{{{\sum }_{{j}_{1} = {i}_{1} - {M}_{1}}^{{i}_{1} + {M}_{1}} [ {\sum }_{{j}_{2} = {i}_{2} - {M}_{2}}^{{i}_{2} + {M}_{2}} {\sum }_{{j}_{3} = {i}_{3} - {M}_{3}}^{{i}_{3} + {M}_{3}} f ( {j}_{1} , {j}_{2} , {j}_{3} ) ]}^{2}}{\begin{matrix}( 2 {M}_{1} + 1 ) ( 2 {M}_{2} + 1 ) ( 2 {M}_{3} + 1 ) \\ {\sum }_{{j}_{1} = {i}_{1} - {M}_{1}}^{{i}_{1} + {M}_{1}} {\sum }_{{j}_{2} = {i}_{2} - {M}_{2}}^{{i}_{2} + {M}_{2}} {\sum }_{{j}_{3} = {i}_{3} - {M}_{3}}^{{i}_{3} + {M}_{3}} {f ( {j}_{1} , {j}_{2} , {j}_{3} )}^{2}\end{matrix}}$$

In the above equation, f(j₁, j₂, j₃) represents an amplitude of each of the seismic sample points within a 3D computation window with side lengths of (2M₁+1), (2M₂+1) and (2M₃+1) respectively, s(i₁, i₂, i₃) represents a coherence result at a center point within the 3D computation window, and s represents a weighted coherence value of an array f(j).

In some embodiments, the fifth processor is specifically configured to:
perform statistics on the fracture development condition from imaging logging to obtain the quantified values of the tectonic characteristic, the lithologic characteristic and the sequence characteristic according to the statistical result, perform normalization processing the quantified values of the tectonic characteristic, the lithologic characteristic and the sequence characteristic, respectively, to obtain normalized values of the tectonic characteristic, the lithologic characteristic and the sequence characteristic, where the statistical result is obtained by identifying and statistically analyzing the fracture characteristic contained in the imaging logging data in the standardized geological database;
compare the normalized values of the tectonic characteristic, the lithologic characteristic and the sequence characteristic with the statistical result respectively, so as to determine the influence weights of the tectonic characteristic, the lithologic characteristic and the sequence characteristic on fracture development; and
based on the influence weights of the tectonic characteristic, the lithologic characteristic and the sequence characteristic, calculate the comprehensive quantified values of the tectonic characteristic, the lithologic characteristic and the sequence characteristic, respectively, by means of weighted combination through the following equations:

$$G = 0.6 {G}_{1} + 0.4 {G}_{2} ;$$

$$Y = 0.7 {Y}_{1} + 0.3 {Y}_{2} ; and$$

$$C = 0. 8 {C}_{1} + 0.2 {C}_{2} .$$

In the above equations, G is the comprehensive quantified value of the tectonic characteristic, G₁ is a quantified curvature value with a corresponding influence weight of 0.6, and G₂ is a quantified linear distance value with a corresponding influence weight of 0.4; Y is the comprehensive quantified value of the lithologic characteristic, Y₁ is a quantified lithology type value with a corresponding influence weight of 0.7, and Y₂ is a quantified lithologic association value with a corresponding influence weight of 0.3; C is the comprehensive quantified value of the sequence characteristic, C₁ is a quantified sequence boundary type value with a corresponding influence weight of 0.8, and C₂ is a dominant interval coincidence degree with a corresponding influence weight of 0.2; and dimensions of G, Y and C all range from 0 to 10.

In some embodiments, the comprehensive quantified values are configured to reflect differences in fracture development potential among different sedimentary microfacies and lithologic associations, as well as the intensity grades of predicted fracture development zones, and further determine main influencing factors for development in the study area.

In some embodiments, the favorable zones for fracture development are classified and graded according to magnitudes of a fracture development potential value A and an intensity value B of tectonic-based predicted fracture development zones.

The favorable zones for fracture development are categorized into three categories, which include first-type favorable zones, second-type favorable zones and third-type favorable zones.

The first-type favorable zones refer to an overlapping portion of sedimentary microfacies where A reaches a maximum value and a region where B falls within a first preset range.

The second-type favorable zones refer to an overlapping portion of sedimentary microfacies where B falls within a second preset range and a region where B falls within a third preset range. The minimum value of the first preset range is greater than the maximum value of the third preset range.

The third-type favorable zones include remaining regions of the predicted fracture development zones, excluding the first-type favorable zones and the second-type favorable zones.

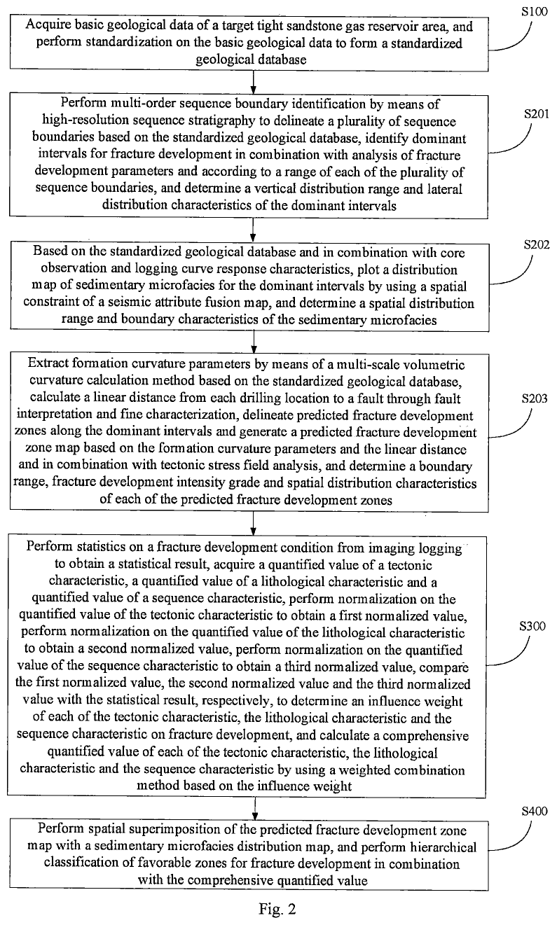

Referring to FIG. 2, a method for predicting fracture development in tight sandstone under a coupling constraint of multiple geological parameters is provided. The embodiments of the method and the embodiments of the system belong to the same inventive concept, and will not be elaborated herein.

The present disclosure will be further described in detail below with reference to the embodiment.

For the target tight sandstone gas reservoir area (hereinafter “target area”) in the 2nd Submember of the 3^{rd} Member of the Xujiahe Formation (T₃x₃²) in the Anyue area of the Central Sichuan Basin, the present application is applied to predict and classify the favorable zones for fracture development. The specific steps are as follows.

### Step (1) Collection and Standardization of Basic Geological Data

Basic geological data of the Anyue area is collected, including 2D seismic data, 3D seismic data, drilling core sample data of 32 wells, imaging logging data, conventional logging data and geological survey reports. The basic geological data is standardized to form a standardized geological database. “Geological structure-sedimentary microfacies-high-frequency sequence” is selected as a core controlling factor for fracture development in tight sandstone, which is a logical chain based on inherent material basis, subsequent dynamic sources and vertical boundary constraints for fracture formation. The sedimentary microfacies determine lithology, grain size and mechanical properties, providing necessary material conditions for fracture initiation. The geological structure provides direct stress dynamics for fracture formation. High-frequency sequence boundaries, through abrupt changes in sedimentary environment, form differences in mechanical properties, thereby constraining vertical distribution of the fractures. These three factors accurately align with the geological background of the target area, characterized by gentle structure and multi-stage sedimentary superposition, thus effectively overcoming the limitations of traditional prediction methods relying on single factors.

### Step (2) Identification Sequence Boundaries and Determination of Dominant Intervals

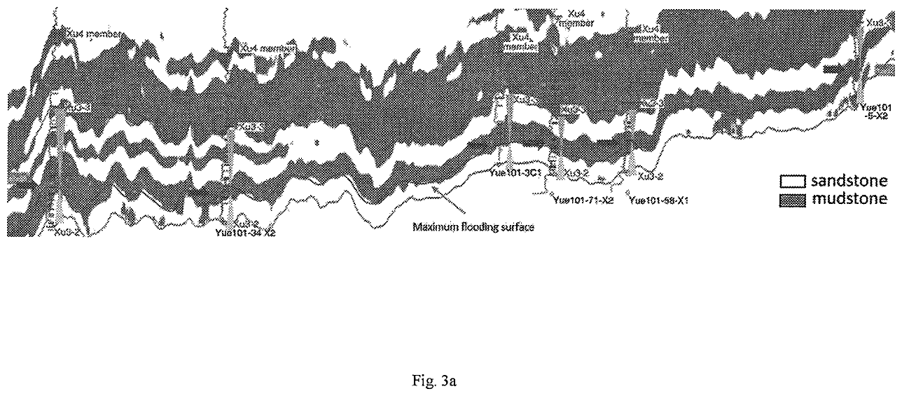

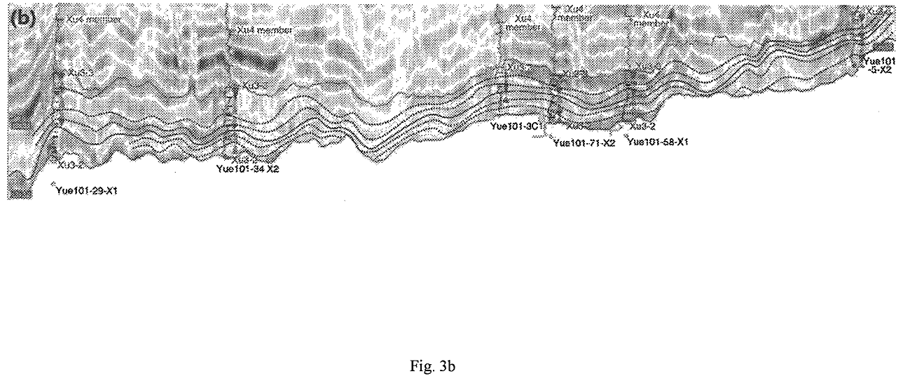

By analyzing the logging curve cyclicity characteristics and the seismic reflection termination relationship, short-term cycle boundaries, medium-term cycle boundaries and maximum flooding surfaces are identified. Sequence boundaries within short-term cycles and transition zones between ascending and descending semi-cycles are determined as dominant intervals for fracture development. Among these, the peripheral area of the maximum flooding surface is the most significant and concentrated dominant interval for fracture development in this layer of the target area. Seismic profile map and sequence division map of the Anyue area are shown in FIGS. 3a-b, respectively.

### Step (3) Sedimentary Microfacies Identification and Mapping

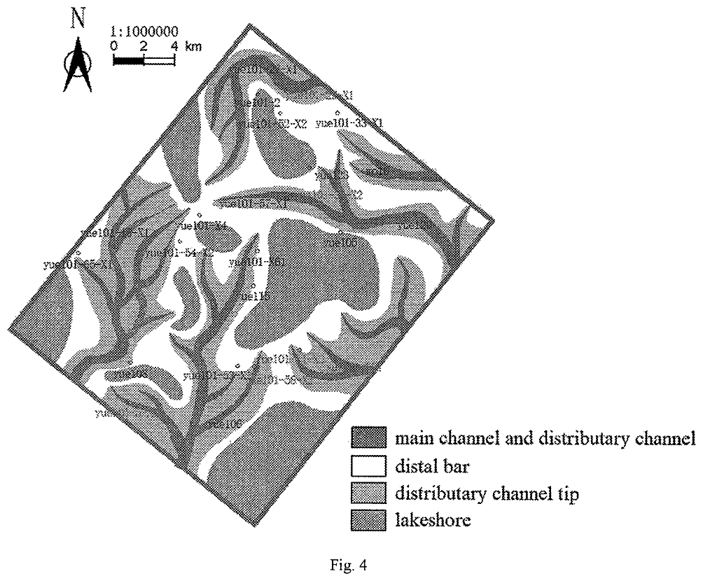

By investigating the drilling core sample data, the imaging logging data, and the conventional logging data of the 32 wells in the target area, lithologies such as fine sandstone, siltstone, medium-coarse sandstone and mudstone are identified. Five lithologic combinations in the target area are classified, including interbedded medium-coarse sandstone and fine sandstone, thick fine sandstone interbedded with siltstone, thick fine siltstone interbedded with medium-thin mudstone, and interbedded medium-thin fine siltstone and mudstone. Sedimentary environments including delta inner front, delta outer front, and prodelta-semi-deep lake are identified. In combination with the logging curve response characteristics, a sedimentary microfacies identification model is established. Using the spatial constraint of the seismic attribute fusion map, a sedimentary microfacies distribution map of the peripheral interval of the maximum flooding surface in the T₃x₃² in the Anyue area is plotted, as shown in FIG. 4.

### Step (4) Extraction and Analysis of Tectonic Parameters

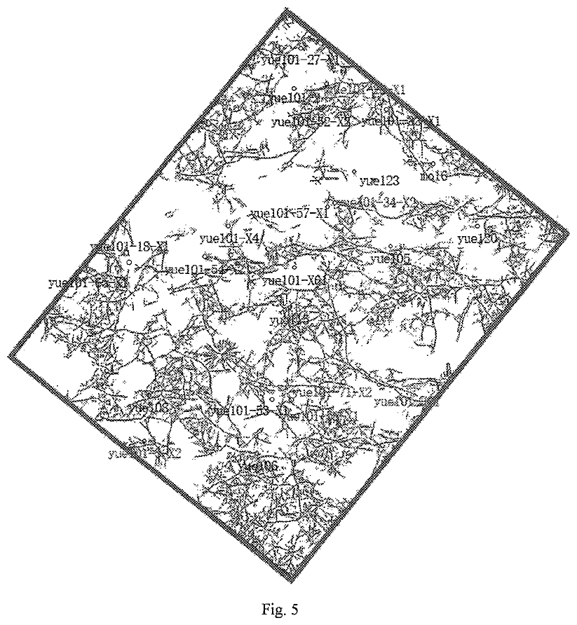

Using the multi-scale volumetric curvature calculation method, parameters such as average formation curvature, maximum positive curvature and minimum negative curvature of the T₃x₃² in the Anyue area are extracted. Statistics show that as these parameters increase from low to high, the total number of fractures gradually rises. The linear distance from each drilling location to the main east-west trending fault is calculated. Based on the relationship between the fracture development direction in individual wells and the distance to fractures of the same orientation, it is determined that these linear distances are negatively correlated with fracture development density. A tectonic characteristic-guided fracture likelihood map for the peripheral intervals of the maximum flooding surface in the T₃x₃² is quantitatively generated, and the predicted fracture development zones based on tectonic characteristic are delineated. The tectonic characteristic-guided fracture likelihood map is shown in FIG. 5.

### Step (5) Establishment of Multi-Parameter Coupling Results

For the well sections in the target area where imaging logging has been completed, fracture development conditions from specific wells are extracted. The fracture development conditions from imaging logging is statistically analyzed to obtain the influence weights and comprehensive quantitative values of the tectonic characteristic, lithological characteristic and sequence characteristic. The comprehensive quantitative value of the tectonic characteristic G is calculated as: G=0.6G₁ (curvature quantitative value, 0-10)+0.4G₂ (linear distance quantitative value, 0-10). The comprehensive quantitative value of the lithological characteristic Y is calculated as: Y=0.7Y₁ (lithology type quantitative value, 0-10, assigned by categories such as fine sandstone, siltstone)+0.3Y₂ (lithology combination quantitative value, 0-10, assigned by types of interbedding/interlayering). The comprehensive quantitative value of the sequence characteristic C is calculated as: C=0.8C₁ (sequence boundary type quantitative value, 0-10, assigned by types such as flooding surfaces)+0.2C₂ (dominant interval conformity, 0-10, assigned based on whether it is a fracture-dominant interval).

The dimensions of G, Y and C are unified to a scale of 0-10 to characterize their influence on fracture development. Regression analysis is performed based on the imaging logging data so that the tectonic characteristic is determined as the main controlling factor for fracture development in the target area.

### Step (6) Classification of Favorable Zones for Fracture Development

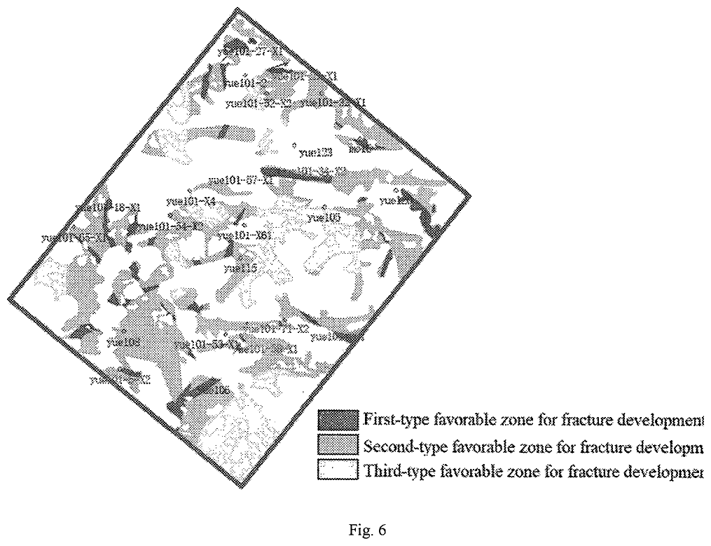

The predicted fracture development zone map based on tectonic characteristic is spatially overlaid with the sedimentary microfacies distribution map, which is combined with the comprehensive quantitative values reflecting the differences in fracture development potential among different sedimentary microfacies and lithologic combinations, as well as the intensity levels of the tectonic-based predicted fracture development zones, to classify the favorable zones for fracture development. Specifically, areas where the delta inner front coincides with the tectonic-based predicted fracture development zones are classified as the first-type favorable zones, areas where the delta outer front coincides with the tectonic-based predicted fracture development zones are classified as the second-type favorable zones, and the remaining tectonic-based predicted fracture development zones are classified as third-type favorable zones. The hierarchical classification results are shown in FIG. 6, which is a favorable fracture development zone map of the T₃x₃² in the Anyue area.

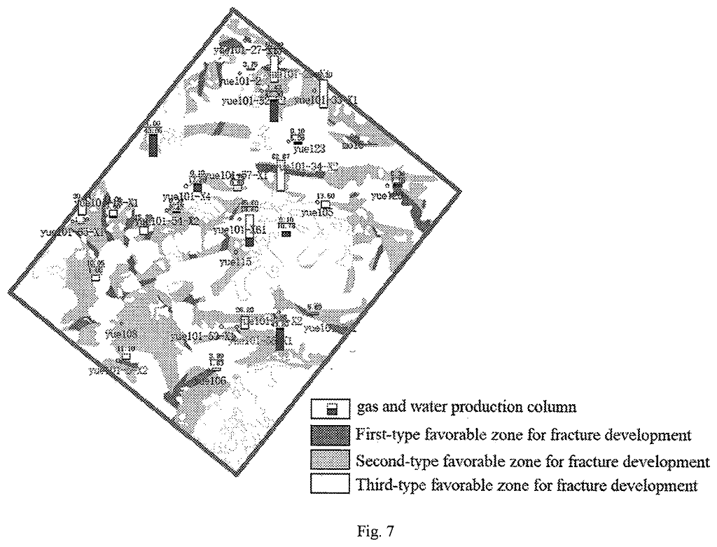

In areas where fracture development dominates reservoir properties, there is a strong positive correlation between the degree of fracture development and the level of oil and gas enrichment. The hierarchical classification results of the present disclosure can reflect the dense zones of tectonic fracture development. The relationship between the favorable zones for fracture development and oil-gas production in the T₃x₃² in the Anyue area is shown in FIG. 7. Thus, the hierarchical classification results can be used to accurately locate potential fractured oil and gas reservoirs, offering remarkable significance in the practical oil-gas production.

The present disclosure also provides a terminal equipment. The terminal equipment includes a processor, a memory and a computer program. The computer program is stored in the memory, and is configured to be executed by the processor. The processor is configured to execute the computer program to implement the steps of the above method, as shown in FIG. 2. In some embodiments, the computer program can be divided into one or more modules. The one or more modules are stored in the memory and executed by the processor to complete the present disclosure. The one or more modules can be a series of computer program instruction segments capable of completing specific functions. The computer program instruction segments are configured to describe an execution process of the computer program in the device for implementing the functions of each processor in the above system.

The device can be a computing device such as a desktop computer, a laptop, a palmtop computer, a cloud server, etc. The terminal device may further include an input and output device, a network access device, a bus, etc.

The processor can be an integrated circuit chip with signal processing capability. The processor can be a general-purpose processor, including a central processing unit (CPU), a network processor (NP), etc., and can also be a digital signal processor (DSP), an application-specific integrated circuit (ASIC), a field-programmable gate array (FPGA) or other programmable logic device, a discrete gate or transistor logic device, or a discrete hardware component. It can implement or execute the various methods, steps, and logic block diagrams disclosed in the embodiments of the present application. The general-purpose processor can be a microprocessor, or the processor can be any conventional processor.

The memory can be an internal storage unit of the terminal equipment, such as a hard disk or an internal storage of the terminal equipment, or can be an external storage device. The memory can include, but is not limited to, a random-access memory (RAM), a read-only memory (ROM), a programmable read-only memory (PROM), an erasable programmable read-only memory (EPROM) and an electrically erasable programmable read-only memory (EEPROM).

When modules integrated by the terminal equipment are implemented in the form of software functional units and sold or used as independent products, they can be stored in a computer-readable storage medium. based on such understanding, the present disclosure can implement all or part of the processes in the above method, which can also be completed by instructing relevant hardware through a computer program. The computer program can be stored in a computer-readable storage medium. When executed by the processor, the computer program can implement the steps of the above method. The computer program includes a computer program code, which can be in a form of a source code, an object code, an executable file or some intermediate form. The computer-readable medium can include any entity or device capable of carrying the computer program code, such as a recording medium a universal serial bus (USB) flash drive, a mobile hard disk, a magnetic disk, an optical disk, a computer memory, a read-only memory, an RAM, an electrical carrier signal, a telecommunications signal and a software distribution medium.

The present disclosure has the following advantages.
(1) The present disclosure integrates the multi-parameter geological parameters of tectonic, lithology and sequence, and establishes a joint control model of “geological structure-sedimentary microfacies-high-frequency sequence”, which overcomes the limitations of traditional single-factor prediction methods and greatly improves the prediction accuracy of favorable zones for fracture development.
(2) Through the quantitative analysis of each characteristic, the prediction and division of favorable zones for fracture development are realized, which achieves the transformation from qualitative description to quantitative prediction, and makes the prediction results more scientific and reliable.
(3) The present disclosure is applicable to the fracture development prediction of various tight sandstone gas reservoirs, and has prominent advantages especially for tight sandstone reservoirs with multi-stage tectonic superposition and complex lithology. It can effectively reduce exploration risks and improve resource utilization efficiency, and thus has broad application prospects.

What is claimed is:

1. A system for predicting fracture development in tight sandstone under a coupling constraint of multiple geological parameters, comprising:
a first processor;
a second processor;
a third processor;
a fourth processor;
a fifth processor; and
a sixth processor;
wherein the first processor is configured to acquire basic geological data of a target tight sandstone gas reservoir area, and perform standardization on the basic geological data to form a standardized geological database;
the second processor is configured to perform multi-order sequence boundary identification by means of high-resolution sequence stratigraphy to delineate a plurality of sequence boundaries based on the standardized geological database, identify dominant intervals for fracture development in combination with analysis of fracture development parameters and according to a range of each of the plurality of sequence boundaries, and determine a vertical distribution range and lateral distribution characteristics of the dominant intervals;
the third processor is configured to, based on the standardized geological database and in combination with core observation and logging curve response characteristics, plot a distribution map of sedimentary microfacies for the dominant intervals by using a spatial constraint of a seismic attribute fusion map, and determine a spatial distribution range and boundary characteristics of the sedimentary microfacies;
the fourth processor is configured to extract formation curvature parameters by means of a multi-scale volumetric curvature calculation method based on the standardized geological database, calculate a linear distance from each drilling location to a fault through fault interpretation and fine characterization, delineate predicted fracture development zones along the dominant intervals and generate a predicted fracture development zone map based on the formation curvature parameters and the linear distance and in combination with tectonic stress field analysis, and determine a boundary range, fracture development intensity grade and spatial distribution characteristics of each of the predicted fracture development zones;
the fifth processor is configured to perform statistics on a fracture development condition from imaging logging to obtain a statistical result, acquire a quantified value of a tectonic characteristic, a quantified value of a lithological characteristic and a quantified value of a sequence characteristic, perform normalization on the quantified value of the tectonic characteristic to obtain a first normalized value, perform normalization on the quantified value of the lithological characteristic to obtain a second normalized value, perform normalization on the quantified value of the sequence characteristic to obtain a third normalized value, compare the first normalized value, the second normalized value and the third normalized value with the statistical result, respectively, to determine an influence weight of each of the tectonic characteristic, the lithological characteristic and the sequence characteristic on fracture development, and calculate a comprehensive quantified value of each of the tectonic characteristic, the lithological characteristic and the sequence characteristic by using a weighted combination method based on the influence weight; and
the sixth processor is configured to perform spatial superimposition of the predicted fracture development zone map with a sedimentary microfacies distribution map, and perform hierarchical classification of favorable zones for fracture development in combination with the comprehensive quantified value.

2. The system of claim 1, wherein the second processor is configured to:
based on the standardized geological database and in combination with logging curve cyclicity characteristics, a seismic reflection termination relationship and core sedimentary sequence analysis, perform multi-order sequence boundary identification by means of high-resolution sequence stratigraphy to delineate the plurality of sequence boundaries, and determine the range, genetic type and distribution pattern of each of the plurality of sequence boundaries; and
analyze a constraining mechanism of a sequence structure on fracture development by performing statistics on the fracture development parameters of the plurality of sequence boundaries and cycle positions; and according to the range of each of the plurality of sequence boundaries, identify the dominant intervals for fracture development, and determine the vertical distribution range and the lateral distribution characteristics of the dominant intervals.

3. The system of claim 2, wherein the third processor is configured to:
acquire drilling core sample data and conventional logging data from the standardized geological database;
based on the drilling core sample data and the conventional logging data, identify a lithology type of each of the dominant intervals through core observation, analyze a rock structure, grain sorting and mineral composition of each of the dominant intervals, and establish a lithology identification model based on the logging curve response characteristics to classify types of lithological combinations of the dominant intervals, and classify the sedimentary microfacies according to the types of the lithological combinations;
perform spatial constraining by using the seismic attribute fusion map, and determine the spatial distribution range and the boundary characteristics of the sedimentary microfacies; and
plot the sedimentary microfacies distribution map for the dominant intervals to present a spatial distribution pattern of the lithological combinations and the sedimentary microfacies.

4. A method for predicting fracture development in tight sandstone under a coupling constraint of multiple geological parameters, comprising:
(1) acquiring basic geological data of a target tight sandstone gas reservoir area, and performing standardization on the basic geological data to form a standardized geological database;
(2) performing multi-order sequence boundary identification by means of high-resolution sequence stratigraphy to delineate a plurality of sequence boundaries based on the standardized geological database, identifying dominant intervals for fracture development in combination with analysis of fracture development parameters and according to a range of each of the plurality of sequence boundaries, and determining a vertical distribution range and lateral distribution characteristics of the dominant intervals;
(3) based on the standardized geological database and in combination with core observation and logging curve response characteristics, plotting a distribution map of sedimentary microfacies for the dominant intervals by using a spatial constraint of a seismic attribute fusion map, and determining a spatial distribution range and boundary characteristics of the sedimentary microfacies;
(4) extracting formation curvature parameters by means of a multi-scale volumetric curvature calculation method based on the standardized geological database, calculating a linear distance from each drilling location to a fault through fault interpretation and fine characterization, delineating predicted fracture development zones along the dominant intervals and generating a predicted fracture development zone map based on the formation curvature parameters and the linear distance and in combination with tectonic stress field analysis, and determining a boundary range, fracture development intensity grade and spatial distribution characteristics of each of the predicted fracture development zones;
(5) performing statistics on a fracture development condition from imaging logging to obtain a statistical result, acquiring a quantified value of a tectonic characteristic, a quantified value of a lithological characteristic and a quantified value of a sequence characteristic, performing normalization on the quantified value of the tectonic characteristic to obtain a first normalized value, performing normalization on the quantified value of the lithological characteristic to obtain a second normalized value, performing normalization on the quantified value of the sequence characteristic to obtain a third normalized value, comparing the first normalized value, the second normalized value and the third normalized value with the statistical result, respectively, to determine an influence weight of each of the tectonic characteristic, the lithological characteristic and the sequence characteristic on fracture development, and calculating a comprehensive quantified value of each of the tectonic characteristic, the lithological characteristic and the sequence characteristic by using a weighted combination method based on the influence weight; and
(6) performing spatial superimposition of the predicted fracture development zone map with a sedimentary microfacies distribution map, and performing hierarchical classification of favorable zones for fracture development in combination with the comprehensive quantified value.

5. The method of claim 4, wherein step (2) comprises:
based on the standardized geological database and in combination with logging curve cyclicity characteristics, a seismic reflection termination relationship and core sedimentary sequence analysis, performing multi-order sequence boundary identification by means of high-resolution sequence stratigraphy to delineate the plurality of sequence boundaries, and determining the range, genetic type and distribution pattern of each of the plurality of sequence boundaries; and
analyzing a constraining mechanism of a sequence structure on fracture development by performing statistics on the fracture development parameters of the plurality of sequence boundaries and cycle positions; and according to the range of each of the plurality of sequence boundaries, identifying the dominant intervals for fracture development, and determining the vertical distribution range and the lateral distribution characteristics of the dominant intervals.

6. The method of claim 5, wherein step (3) comprises:
acquiring drilling core sample data and conventional logging data from the standardized geological database;
based on the drilling core sample data and the conventional logging data, identifying a lithology type of each of the dominant intervals through core observation, analyzing a rock structure, grain sorting and mineral composition of each of the dominant intervals, and establishing a lithology identification model based on the logging curve response characteristics to classify types of lithological combinations of the dominant intervals, and classifying the sedimentary microfacies according to the types of the lithological combinations;
performing spatial constraining by using the seismic attribute fusion map, and determining the spatial distribution range and the boundary characteristics of the sedimentary microfacies; and
plotting the sedimentary microfacies distribution map for the dominant intervals to present a spatial distribution pattern of the lithological combinations and the sedimentary microfacies.
